(19) United States
(12) Patent Application Publication
(10) Pub. No.: US 2014/0064606 A1
(43) Pub. Date: Mar. 6, 2014

(54) IMAGE PROCESSING APPARATUS AND IMAGE PROCESSING METHOD

(71) Applicant: Sony Corporation, Tokyo (JP)

(72) Inventors: Kentaro Doba, Tokyo (JP); Yota Komoriya, Tokyo (JP)

(73) Assignee: Sony Corporation, Tokyo (JP)

(21) Appl. No.: 13/972,079

(22) Filed: Aug. 21, 2013

(30) Foreign Application Priority Data
Sep. 4, 2012 (JP) 2012-194539

(51) Int. Cl. G06T 5/00

(52) U.S. Cl. CPC G06T 5/002
USPC 382/154

(57) ABSTRACT

There is provided an image processing apparatus including a difference value calculation section which associates, with each other on a tone basis, histograms indicating a number of pixels per tone in a left-eye image and a right-eye image, respectively, the left-eye image and the right-eye image being components of a stereoscopic image, which calculates a difference value between the left-eye image and the right-eye image on the associated tone basis, and which smooths the calculated difference value among tones, and a correction section which corrects the left-eye image or the right-eye image based on the smoothed tone-basis difference value.

### BACKGROUND

The present disclosure relates to an image processing apparatus and an image processing method.

An apparatus has been increasingly spread which displays, for example, an image corresponding to the view of the left eye of a user (hereinafter, referred to as a “left-eye image”) and an image corresponding to the view of the right eye of the user (hereinafter, referred to as a “left-eye image”) on a display screen and thereby can cause the user to recognize the displayed image as a stereoscopic image. The apparatus as described above utilizes a parallax to cause the user to recognize the displayed image as the stereoscopic image.

The left-eye and right-eye images as described above which are components of the stereoscopic image (hereinafter, sometimes referred to as a “stereo image”) are obtained, for example, by capturing images of an image-capturing target by using two imaging apparatuses. However, color discrepancy between the left-eye and right-eye images might be caused by, for example, a difference in reflection light from the image-capturing target, exposure parameters, or location between the two imaging apparatuses. Meanwhile, imaging of stereo images has been actively performed by using a semitransparent mirror in recent years. The color discrepancy between the left-eye and right-eye images is also caused by, for example, an optical characteristic difference due to angles made between the semitransparent mirror and an imaging apparatus.

Under such circumstances, technology for correcting color discrepancy between the left-eye and right-eye images has been developed. Examples of the technology for correcting color discrepancy between the left-eye and right-eye images include technology described in JP 2007-535829A.

### SUMMARY

An image processing apparatus using the technology described in JP 2007-535829A, for example, calculates a histogram indicating the number of pixels per tone (color histogram) of each of a left-eye image (hereinafter, sometimes referred to as “L” simply) and a right-eye image (hereinafter, sometimes referred to as “R” simply), and associates the histogram of the left-eye image and the histogram of the right-eye image with each other. Then, the image processing apparatus using the technology described in JP 2007-535829A, for example, corrects the color of the left-eye image or the color of the right-eye image based on the associated result. Thus, when the technology described in JP 2007-535829A, for example, is used, there is a possibility that color discrepancy between the left-eye and right-eye images can be corrected.

In the technology described in JP 2007-535829A, for example, the histograms of the left-eye and right-eye images are associated with each other by: a method using DP (Dynamic Programming) matching for the histograms; or a method for associating histograms with each other by extracting characteristic tone values such as peaks from the histograms. However, when the color of the left-eye or right-eye image is corrected based on a result of the association performed by the method simply using the DP matching, a corrected image might be unnatural because the gradation is not smooth. When the color of the left-eye or right-eye image is corrected based on a result of the association performed by the association method using extraction of characteristic tone values such as peaks from the histograms, tone values not selected as representatives are not corrected with sufficient accuracy.

Accordingly, even if the technology described in JP 2007-535829A, for example, is used, it is not necessarily possible to accurately correct color discrepancy between the left-eye and right-eye images.

Hence, it is desirable to provide an image processing apparatus and an image processing method which are novel and improved and which can enhance the accuracy of correcting color discrepancy between the left-eye and right-eye images which are components of a stereoscopic image.

According to an embodiment of the present disclosure, there is provided an image processing apparatus including a difference value calculation section which associates, with each other on a tone basis, histograms indicating a number of pixels per tone in a left-eye image and a right-eye image, respectively, the left-eye image and the right-eye image being components of a stereoscopic image, which calculates a difference value between the left-eye image and the right-eye image on the associated tone basis, and which smooths the calculated difference value among tones, and a correction section which corrects the left-eye image or the right-eye image based on the smoothed tone-basis difference value.

Further, according to an embodiment of the present disclosure, there is provided an image processing method including associating, with each other on a tone basis, histograms indicating the number of pixels per tone in a left-eye image and a right-eye image, respectively, the left-eye image and the right-eye image being components of a stereoscopic image, calculating a difference value between the left-eye image and the right-eye image on the associated tone basis, and smoothing the calculated difference value among tones, and correcting the left-eye image or the right-eye image based on the smoothed tone-basis difference value.

According to the present embodiment of the present disclosure, it is possible to enhance the accuracy of correcting color discrepancy between the left-eye and right-eye images which are components of a stereoscopic image.

### BRIEF DESCRIPTION OF THE DRAWINGS

FIGS. 1A and 1B are explanatory views for illustrating a first example of possible trouble in using an existing image processing method;

FIGS. 2A and 2B are explanatory views for illustrating the first example of possible trouble in using an existing image processing method;

FIGS. 3A and 3B are explanatory views for illustrating the first example of possible trouble in using an existing image processing method;

FIGS. 4A and 4B are explanatory views for illustrating a second example of possible trouble in using an existing image processing method;

FIGS. 5A and 5B are explanatory views for illustrating the second example of possible trouble in using an existing image processing method;

FIGS. 6A, 6B, and 6C are explanatory views for illustrating the second example of possible trouble in using an existing image processing method;

FIGS. 7A and 7B are explanatory views for illustrating a third example of possible trouble in using an existing image processing method;

FIGS. 8A and 8B are explanatory views for illustrating the third example of possible trouble in using an existing image processing method;

FIGS. 9A, 9B, 9C, 9D, and 9E are explanatory views and graphs for illustrating an outline of processing according to the present embodiment;

FIG. 10 is a flowchart illustrating a first example of an image processing method according to the present embodiment in an image processing apparatus in the present embodiment;

FIG. 11 is a flowchart illustrating a second example of an image processing method according to the present embodiment in an image processing apparatus in the present embodiment;

FIGS. 12A and 12B are explanatory views illustrating a first example of an image corrected by using the image processing method according to the present embodiment;

FIGS. 13A, 13B, and 13C are explanatory views illustrating a second example of an image corrected by using the image processing method according to the present embodiment;

FIGS. 14A and 14B are explanatory views illustrating a third example of an image corrected by using the image processing method according to the present embodiment;

FIGS. 15A and 15B are explanatory views illustrating a fourth example of an image corrected by using the image processing method according to the present embodiment;

FIGS. 16A and 16B are explanatory views illustrating the fourth example of an image corrected by using the image processing method according to the present embodiment;

FIG. 17 is a block diagram illustrating an example of a configuration of the image processing apparatus according to the present embodiment; and

FIG. 18 is an explanatory view illustrating an example of a hardware configuration of the image processing apparatus according to the present embodiment.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description is given below in the following order.

1. Image processing method according to present embodiment
2. Image processing apparatus according to present embodiment
3. Program according to the present embodiment

### (Image Processing Method According to Present Embodiment)

Before a description of a configuration of an image processing apparatus according to the present embodiment, a description is firstly given of an image processing method according to the present embodiment. The image processing method according to the present embodiment will be described below by taking as an example where the image processing apparatus according to the present embodiment performs processing according to the image processing method according to the present embodiment.

### [1] Examples of Possible Trouble in Using Existing Image Processing Method

Firstly, a description is given of specific examples of possible trouble in using an existing image processing method, such as the technology described in JP 2007-535829A.

### (A) First Example

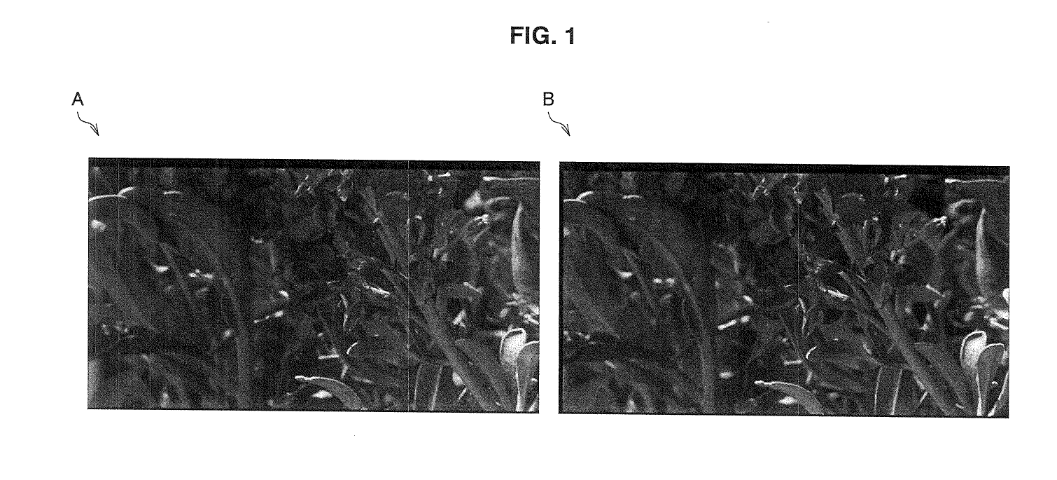

FIG. 1 is an explanatory view for illustrating a first example of possible trouble in using an existing image processing method, and illustrates original images to which the existing image processing method has not been applied yet. FIG. 1A illustrates a left-eye image (original image), while FIG. 1B illustrates a right-eye image (original image).

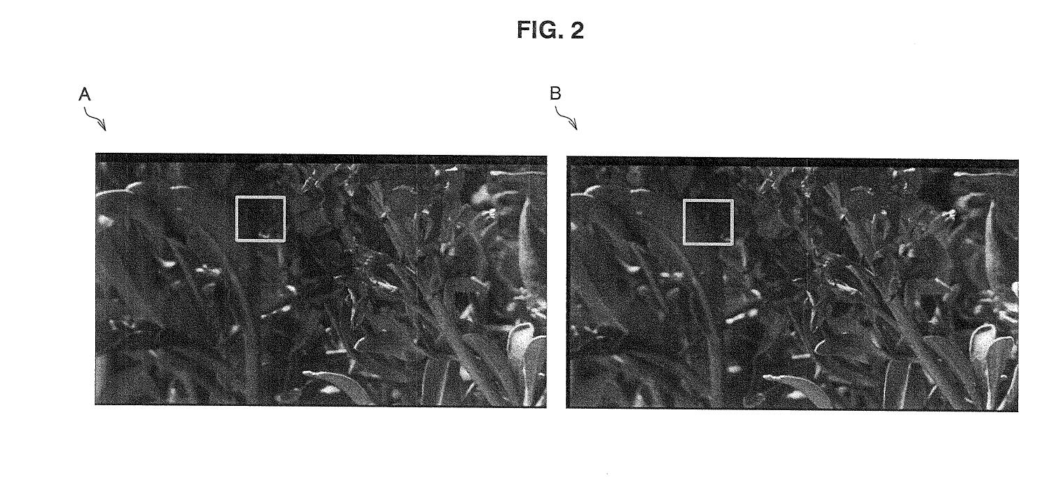

FIG. 2 is an explanatory view for illustrating the first example of possible trouble in using the existing image processing method, and illustrates an example of an image obtained by correcting one of the images illustrated in FIG. 1 using the technology described in JP 2007-535829A. FIG. 2A illustrates an example of a corrected left-eye image, while FIG. 2B illustrates the original right-eye image.

In comparison between a portion in a square in FIG. 2A and a portion in a square in FIG. 2B, a relatively dark color in the portion in the square in FIG. 2A is not clear, and there is color discrepancy between the left-eye and right-eye images. The color discrepancy in FIG. 2 takes place due to incapability of coping with local color discrepancy, for example.

To cope with the local color discrepancy as illustrated in FIG. 2, the following method is conceivable. For example, the left-eye image (original image) in FIG. 1A and the right-eye image (original image) in FIG. 1B are each divided into regions, and the right-eye or left-eye image is corrected on the basis of divided regions corresponding to each other in the right-eye and left-eye images.

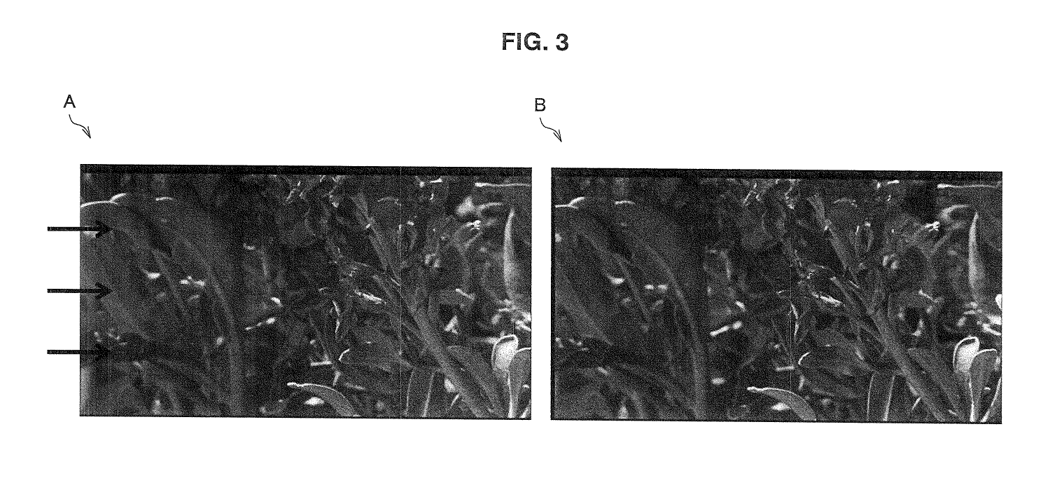

FIG. 3 is an explanatory view for illustrating the first example of possible trouble in using the existing image processing method, and illustrates an example of an image corrected after the left-eye image (original image) in FIG. 1A and the right-eye image (original image) in FIG. 1B are each divided into regions, the image being corrected on the basis of divided regions corresponding to each other by using the technology described in JP 2007-535829A. FIG. 3A illustrates an example of a corrected left-eye image, while FIG. 3B illustrates the original right-eye image. FIG. 3 illustrates the examples of images obtained in such a manner that the left-eye image (original image) in FIG. 1A and the right-eye image (original image) in FIG. 1B are each vertically divided into eight regions and then processed.

In the case where the left-eye and right eye images (original images) are each divided and are corrected on the corresponding divided region basis by using the technology described in JP 2007-535829A, a line could appear on a boundary between the divided regions in the corrected image, as shown in a portion indicated by the arrows in FIG. 3A. Accordingly, accurate correction of color discrepancy between the left-eye and right-eye images is not expected from simply correcting the right-eye or left-eye image on the divided region basis.

### (B) Second Example

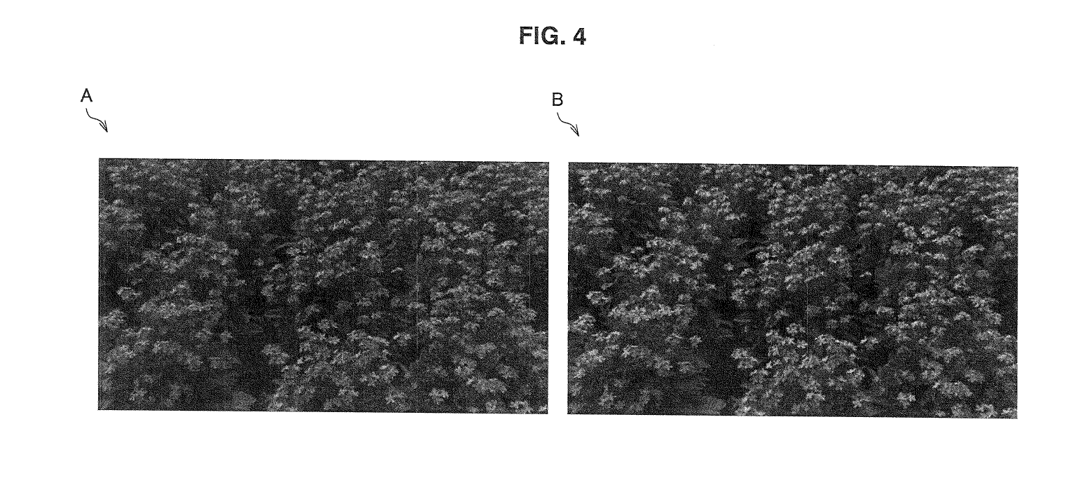

FIG. 4 is an explanatory view for illustrating a second example of possible trouble in using the existing image processing method, and illustrates original images to which the existing image processing method has not been applied yet. FIG. 4A illustrates a left-eye image (original image), while FIG. 4B illustrates a right-eye image (original image).

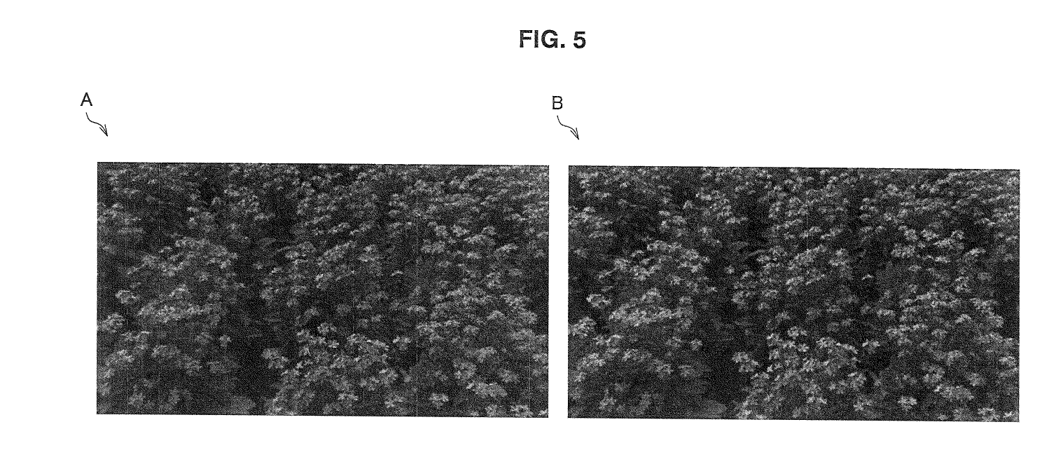

FIG. 5 is an explanatory view for illustrating the second example of possible trouble in using the existing image processing method, and illustrates an example of an image obtained by correcting one of the images in FIG. 4 by using the technology described in JP 2007-535829A. FIG. 5A illustrates an example of a corrected left-eye image, while FIG. 5B illustrates the original right-eye image.

In comparison between FIG. 5A and FIG. 5B, the corrected left-eye image in FIG. 5A has an upper greenish portion and a lower reddish portion. That is, in the second example in FIG. 5, there is color discrepancy between the left-eye and right-eye images in the entire images.

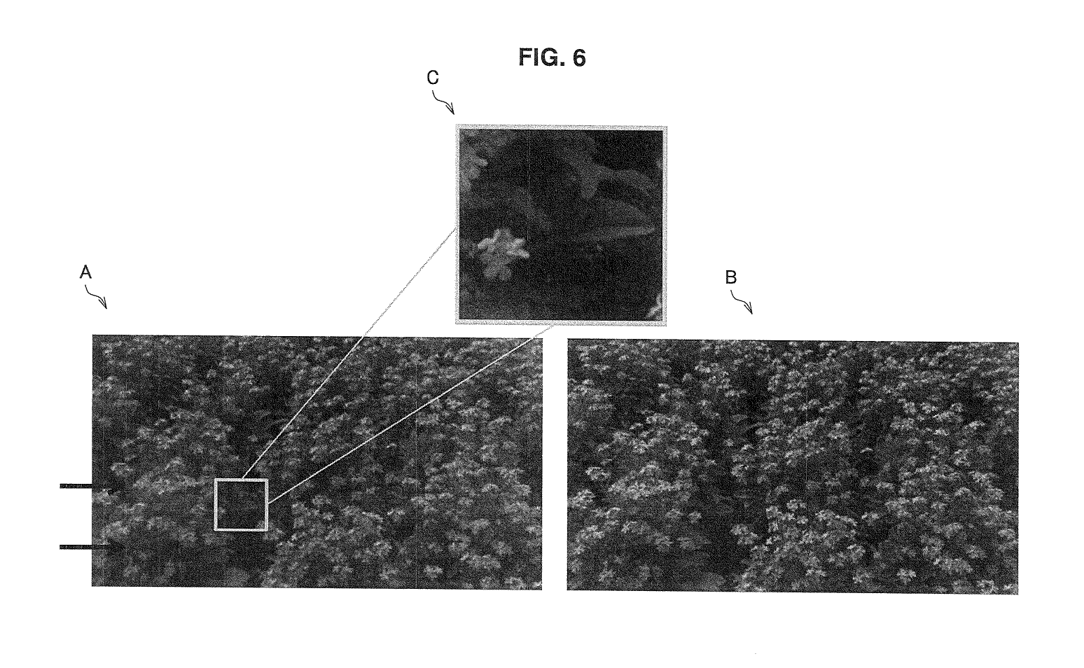

FIG. 6 is an explanatory view for illustrating the second example of possible trouble in using the existing image processing method, and illustrates an example of an image corrected after the left-eye image (original image) in FIG. 4A and the right-eye image (original image) in FIG. 4B are each divided into regions, the image being corrected on the corresponding divided region basis using the technology described in JP 2007-535829A. FIG. 6A illustrates an example of a corrected left-eye image, while FIG. 6B illustrates the original right-eye image. Moreover, FIG. 6C illustrates a portion in a square shown in FIG. 6A. FIG. 6 illustrates the example of the images obtained in such a manner that the left-eye image (original image) in FIG. 4A and the right-eye image (original image) in FIG. 4B are each vertically divided into eight regions and then processed.

In the case where the left-eye and right eye images (original images) are each divided and are corrected on the corresponding divided region basis by using the technology described in JP 2007-535829A, a line could appear on a boundary between the divided regions in the corrected image, as shown in a portion indicated by the arrows in FIG. 6A. In addition, in the case where the left-eye and right eye images (original images) are each divided and are corrected on the corresponding divided region basis by using the technology described in JP 2007-535829A, rough gradation might also take place as illustrated in FIG. 6C. Accordingly, accurate correction of color discrepancy between the left-eye and right-eye images is not expected from simply correcting the right-eye or left-eye image on the divided region basis.

### (C) Third Example

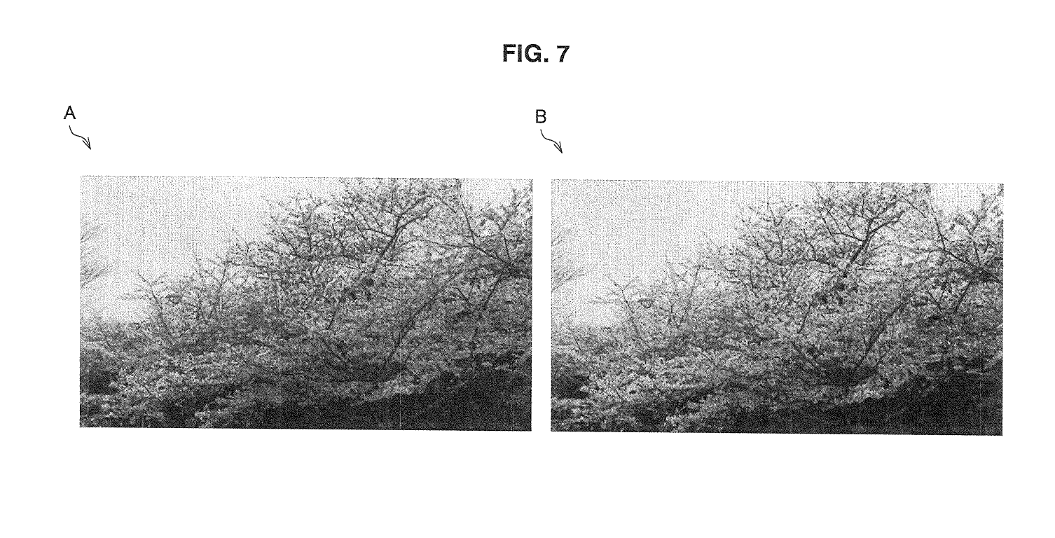

FIG. 7 is an explanatory view for illustrating a third example of possible trouble in using the existing image processing method, and illustrates original images to which the existing image processing method has not been applied yet. FIG. 7A illustrates a left-eye image (original image), while FIG. 7B illustrates a right-eye image (original image).

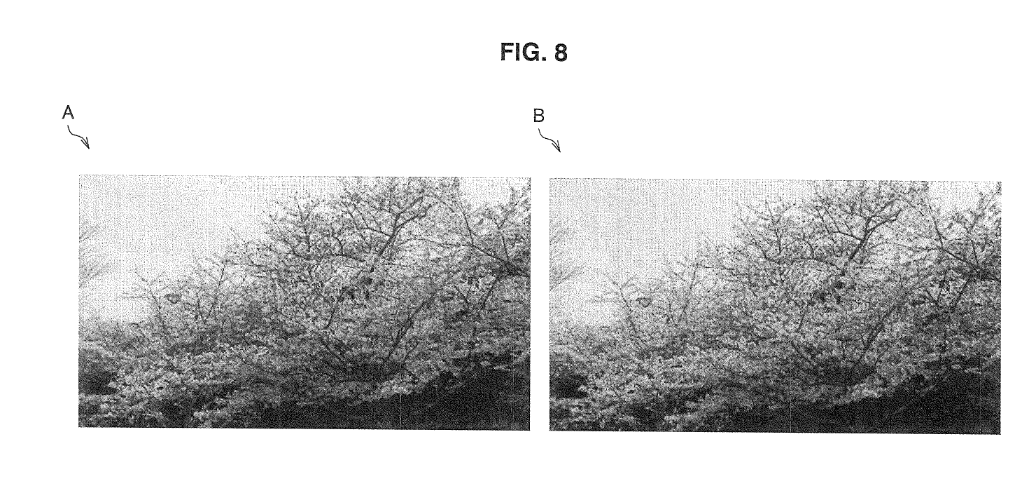

FIG. 8 is an explanatory view for illustrating the third example of possible trouble in using the existing image processing method, and illustrates an example of an image obtained by correcting one of the images illustrated in FIG. 7 by using the technology described in JP 2007-535829A. FIG. 8A illustrates an example of a corrected left-eye image, while FIG. 8B illustrates the original right-eye image.

In comparison between FIG. 8A and FIG. 8B, the corrected left-eye image in FIG. 8A is corrected so that the entire image is reddish. However, a lower portion of the image is too reddish, and an upper portion thereof is greenish. That is, in the third example in FIG. 8, there is color discrepancy between the left-eye and right-eye images in the entire images as in the second example in FIG. 5.

As shown in the first to third examples of the possible trouble in using the existing image processing method, even though the existing image processing method such as the technology described in JP 2007-535829A is used, accurate correction of color discrepancy between the left-eye and right-eye images is not expected.

### [2] Image Processing Method According to Present Embodiment

### [2-1] Outline of Image Processing Method According to Present Embodiment

Hence, an image processing apparatus according to the present embodiment calculates a difference value between the left-eye and right-eye images (color difference value) on the tone basis, and smooths the calculated difference value among the tones (difference value calculation processing). Then, the image processing apparatus according to the present embodiment corrects one of images or the other image based on the smoothed tone-basis difference value (correction processing).

Here, a left-eye image and a right-eye image to be processed by the image processing apparatus according to the present embodiment may be, for example, still images or frame images forming a moving image.

In addition, examples of the processing target left-eye and right-eye images according to the present embodiment include images corresponding to image data read by the image processing apparatus according to the present embodiment from a storage section (to be described later) or an external recording medium. Note that the target left-eye and right-eye images according to the present embodiment are not limited to those described above. For example, the target left-eye and right-eye images according to the present embodiment may be images indicated by signals received by a communication section (to be described later) or images captured by an imaging section (to be described later).

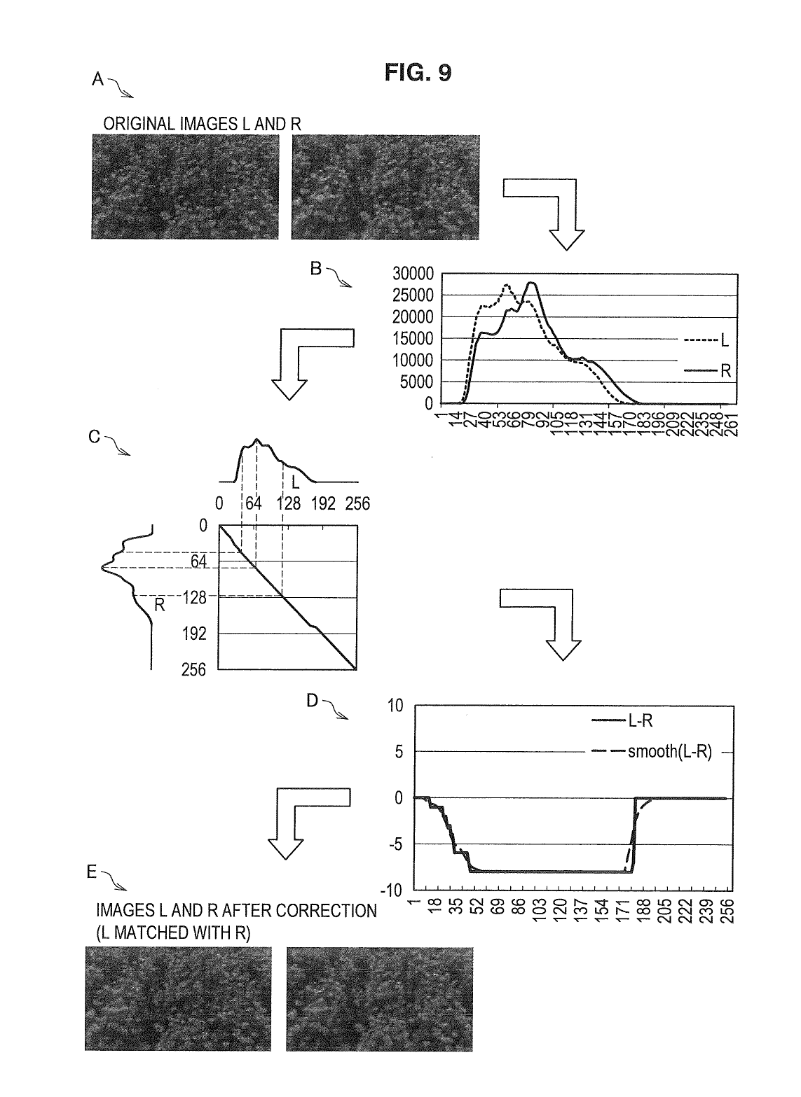

FIG. 9 is an explanatory view for illustrating an outline of processing of the image processing method according to the present embodiment. Here, FIG. 9A illustrates original images of a left-eye image and a right-eye image. FIGS. 9B, 9C, and 9D illustrate an example of difference value calculation processing according to the present embodiment. FIG. 9E illustrates an example of a corrected image obtained as a result of correction processing according to the present embodiment.

Hereinbelow, the difference value calculation processing and the correction processing according to the image processing method according to the present embodiment will be described with reference to FIG. 9 as appropriate.

### (1) Difference Value Calculation Processing

For example, as illustrated in FIG. 9B, the image processing apparatus according to the present embodiment calculates a histogram indicating the number of pixels per tone of each of a left-eye image and a right-eye image which are components of a stereoscopic image. In FIG. 9B, the horizontal axis represents tones, and the vertical axis represents the degree.

Although the image processing apparatus according to the present embodiment calculates the histograms indicating the number of pixels per tone by using the original left-eye and right-eye images themselves, the processing according to the histogram calculation in the image processing apparatus according to the present embodiment is not limited to that described above. For example, the image processing apparatus according to the present embodiment may calculate the histograms in such a manner as to decrease the number of tone bits of the original left-eye and right-eye images. Examples of a method for decreasing the number of tone bits of the original left-eye and right-eye images include eliminating lower M (M is a positive integer) bits of the tone bits of the original left-eye and right-eye images.

As described above, the image processing apparatus according to the present embodiment calculates the histograms in such a manner as to decrease the number of tone bits of the original left-eye and right-eye images, and thereby it is possible to reduce the scattering of the degrees in the tones. The calculation of the histograms with the decreased number of tone bits of the original left-eye and right-eye images as described above reduces a calculation amount of the difference value calculation processing.

In addition, for example, as illustrated in FIG. 9C, the image processing apparatus according to the present embodiment associates the histograms indicating the number of pixels per tone of the left-eye and right-eye images with each other on a tone basis (matching processing). After the association per tone in the matching processing, the image processing apparatus according to the present embodiment records, for example, results of the association per tone in lookup tables (color lookup table s).

Meanwhile, the image processing apparatus according to the present embodiment selects a lowest cost combination by using DP (Dynamic Programming), for example, and thereby associates the histograms indicating the number of pixels per tone of the respective left-eye and right-eye images, with each other on the tone basis. Note that the matching processing in the difference value calculation processing according to the present embodiment is not limited to the processing using DP. For example, the image processing apparatus according to the present embodiment can associate the histograms indicating the number of pixels per tone of the respective left-eye and right-eye images with each other on the tone basis by using any one-dimensional matching technique.

After the association of the histograms indicating the number of pixels per tone of the left-eye and right-eye images with each other on the tone basis, the image processing apparatus according to the present embodiment calculates, on the tone basis, a difference value of one of the right-eye image and the left-eye image from the other. For example, by subtracting the degree of the right-eye image from the degree of the left-eye image on the associated tone basis, or by subtracting the degree of the left-eye image from the degree of the right-eye image on the associated tone basis, the image processing apparatus according to the present embodiment calculates the difference value per associated tone.

Here, if the left-eye image (original image) or the right-eye image (original image) is corrected by using the calculated difference value, it is possible to correct color discrepancy between the left-eye and right-eye images to some extent. However, when the left-eye image (original image) or the right-eye image (original image) is corrected by using the calculated difference value, there is a risk of the local color discrepancy as in the possible trouble in using the existing image processing method described above.

Hence, the image processing apparatus according to the present embodiment further smooths the calculated difference value among the tones in the difference value calculation processing.

More specifically, for example, the image processing apparatus according to the present embodiment calculates, on the tone basis, a weighted average of the calculated difference value and difference values of N (N is an integer of 1 or larger) tones higher than the tone of the calculated value and N tones lower than the tone, and thereby smooths the calculated difference value among the tones. Note that the smoothing of the calculated difference value among the tones by the image processing apparatus according to the present embodiment is not limited to the smoothing using the weighted average, and may be performed by using another technique enabling smoothing, such as an arithmetic average.

FIG. 9D illustrates an example of difference values (“L−R” in FIG. 9D) and an example of smoothed difference values (“Smooth (L−R)” in FIG. 9D). By smoothing the difference values among the tones as illustrated in FIG. 9D, and by correcting, in the correction processing to be described later, the left-eye image (original image) or the right-eye image (original image) by using the corresponding smoothed difference value, the local color discrepancy can be reduced further. Note that a description is given later of specific examples of images corrected by using the image processing method according to the present embodiment.

### (2) Correction Processing

The image processing apparatus according to the present embodiment corrects the left-eye or right-eye image based on the tone-basis difference value smoothed in the processing (difference value calculation processing) described in (1) above.

More specifically, the image processing apparatus according to the present embodiment obtains a corrected image of which color is corrected, for example, by adding or subtracting the smoothed difference value to or from a pixel value of the original image. For example, FIG. 9E illustrates an example of matching the left-eye image with the right-eye image by subtracting the smoothed difference value from the pixel value of the left-eye image (original image) in FIG. 9A.

The image processing apparatus according to the present embodiment corrects the color of the left-eye or right-eye image, for example, by performing the processing (difference value calculation processing) described in (1) above and the processing (correction processing) described in (2) above.

Here, the image processing apparatus according to the present embodiment calculates the difference value between the left-eye and right-eye images on the associated tone basis in the processing (difference value calculation processing) described in (1) above, and smooths the calculated difference value among the tones. Then, the image processing apparatus according to the present embodiment corrects the left-eye or right-eye image based on the smoothed tone-basis difference value in the processing (correction processing) described in (2) above. Thus, the image processing apparatus according to the present embodiment can further reduce local color discrepancy possibly occurring in using the existing image processing method described above.

Accordingly, the image processing apparatus according to the present embodiment can enhance the accuracy of correcting color discrepancy between the left-eye and right-eye images which are components of a stereoscopic image by performing, for example, the processing (difference value calculation processing) described in (1) above and the processing (correction processing) described in (2) above.

Note that the processing according to the image processing method according to the present embodiment is not limited to the processing (difference value calculation processing) described in (1) above and the processing (correction processing) described in (2) above.

For example, the image processing apparatus according to the present embodiment may correct the color of the left-eye or right-eye image by dividing each of the left-eye and right-eye images, and by performing the processing (difference value calculation processing) described in (1) above and the processing (correction processing) described in (2) above on the corresponding divided region basis.

More specifically, in the processing (difference value calculation processing) described in (1) above, the image processing apparatus according to the present embodiment divides each of the left-eye and right-eye images and calculates a difference value between the left-eye and right-eye images on the corresponding divided region basis. In the processing (difference value calculation processing) described in (1) above, the image processing apparatus according to the present embodiment also smooths, among the tones on the divided region basis, the difference value thus calculated on the divided region basis. Then, in the processing (correction processing) described in (2) above, the image processing apparatus according to the present embodiment corrects the left-eye or right-eye image on the vided region basis.

Here, the image processing apparatus according to the present embodiment, for example, vertically divides each of the left-eye and right-eye images. This is because the vertical division is effective to cope with a difference in color discrepancy between vertical positions. It goes without saying that the image processing apparatus according to the present embodiment can horizontally divide, or horizontally and vertically divide each of the left-eye and right-eye images.

In addition, the image processing apparatus according to the present embodiment sets the number of divided regions based on “the necessity of regions with approximately several tens to several hundreds of lines for obtaining the degree high enough to associate histograms with each other”. Examples of the number of divided regions according to the present embodiment of the left-eye and right-eye images include eight (an example of the number of divided regions set in advance). However, the number of divided regions according to the present embodiment is not limited to the number described above. For example, the image processing apparatus according to the present embodiment may set the number of divided regions appropriate for the left-eye and right-eye images to be processed, by referring to a lookup table in which image sizes stored in the storage section (to be described later) or the like and the number of divided regions are associated with each other. Alternatively, the image processing apparatus according to the present embodiment may set the number of divided regions based on the user manipulation, for example.

As described above, performing the processing (difference value calculation processing) described in (1) above on the divided region basis and performing the processing (correction processing) described in (2) above on the divided region basis make it possible to further reduce the possible local color discrepancy between the left-eye and right-eye images.

In addition, the image processing apparatus according to the present embodiment may further smooth the smoothed tone-basis difference value between adjacent divided regions in the processing (difference value calculation processing) described in (1) above.

Here, suppose a case where there is a difference in color difference value between adjacent divided regions, for example. In this case, when the smoothing is performed among the tones on the divided region basis and when the processing (correction processing) described in (2) above is then performed on the divided region basis, the difference in color difference value between the adjacent divided regions might cause an unnatural break in a corrected image. However, since the image processing apparatus according to the present embodiment further smooths the smoothed tone-basis difference value between the adjacent divided regions as described above, it is possible to prevent occurrence of a possible unnatural break in an image caused by, for example, a difference in color difference value between divided regions.

Further, the image processing apparatus according to the present embodiment may generate, for example, one or more images each in a viewpoint different from the viewpoints of the left-eye and right-eye images (viewpoint-image generation processing).

The image processing apparatus according to the present embodiment sets, for example, the left-eye or right-eye image as a reference image, and generates an image in which the reference image is shifted by a set phase difference. Here, the set phase difference may be a fixed value set in advance or a variable value changeable by the user.

Note that the viewpoint-image generation processing in the image processing apparatus according to the present embodiment is not limited to that described above. For example, the image processing apparatus according to the present embodiment may generate an image in another viewpoint by performing processing according to any viewpoint-image-generation technique enabling generation of an image in another viewpoint (multi-view image generation processing, for example).

### [2-2] Processing According to Image Processing Method According to Present Embodiment

Next, a description is given of specific examples of the processing according to the image processing method according to the present embodiment described above.

Hereinbelow, the description is given by taking as an example a case where a left-eye image (original image) and a right-eye image (original image) processed by the image processing apparatus according to the present embodiment are each an image in, for example, “RGB, 1080p, and 10-bit tones”. Note that the left-eye and right eye images (original images) processed by the image processing apparatus according to the present embodiment are not limited to those described above. For example, the left-eye and right eye images (original images) processed by the image processing apparatus according to the present embodiment may be images in any format.

The description is given below by also taking as an example a case where the image processing apparatus according to the present embodiment corrects the left-eye image by using the right-eye image as a reference image (the case of matching the color of the left-eye image with the color of the right-eye image). Note that the image processing apparatus according to the present embodiment may correct the right-eye image by using the left-eye image as the reference image (in other words, the color of the right-eye image may be matched with the color of the left-eye image).

### (I) First Example of Processing According to Image Processing Method According to Present Embodiment

FIG. 10 is a flowchart illustrating a first example of the processing according to the image processing method according to the present embodiment in the image processing apparatus according to the present embodiment. Processing in Steps S100 to S104 in FIG. 10 corresponds to the processing (difference value calculation processing) described in (1) above. Processing in Step S106 in FIG. 10 corresponds to the processing (correction processing) described in (2) above. In FIG. 10, the left-eye and right-eye images are represented by “L” and “R”, respectively.

The image processing apparatus according to the present embodiment obtains a histogram of each of the left-eye and right-eye images (S100). Here, the image processing apparatus according to the present embodiment calculates the histograms using 8-bit tones (256 tones), for example, by eliminating lower two bits of each pixel value of the left-eye and right-eye images. Note that the number of tone bits of each histogram calculated by the image processing apparatus according to the present embodiment is not limited to the number described above. For example, the image processing apparatus according to the present embodiment may generate histograms in 10-bit tones (1024 levels) by using pixel values of the left-eye and right-eye images. The image processing apparatus according to the present embodiment may also calculate histograms in tones having approximately a half of tone bits of the left-eye and right-eye images, for example, by eliminating lower five bits or lower four bits of each pixel value of the left-eye and right-eye images.

The image processing apparatus according to the present embodiment associates the histograms of the respective left-eye and right-eye images calculated in Step S100 with each other on the tone basis (S102). For example, the image processing apparatus according to the present embodiment performs the DP matching to associate tones having mutually close degree values in the histograms with each other. The image processing apparatus according to the present embodiment also records, for example, results of the association per tone in the color lookup tables of the left-eye and right-eye images.

After the association in Step S102, the image processing apparatus according to the present embodiment smooths, among the tones, the color difference value between the left-eye and right-eye images which is obtained by the association (S104).

More specifically, the image processing apparatus according to the present embodiment calculates the difference value between the left-eye and right-eye images on the associated tone basis, for example, by referring to the lookup tables. Then, the image processing apparatus according to the present embodiment smooths the tone-basis difference value among the tones, for example, by calculating, on the tone basis, a weighted average of the calculated difference value and difference values of three tones higher than the tone of the calculated value and three tones lower than the tone. Note that the number of taps for the smoothing among the tones may be fixed or variable based on the user manipulation.

For example, if lower bits of each pixel value of the left-eye and right-eye images are eliminated in Step S100, the image processing apparatus according to the present embodiment extends each difference value to have the original number of bits by using linear interpolation, for example. For example, if lower two bits of each pixel value of the left-eye and right-eye images are eliminated in Step S100, the image processing apparatus according to the present embodiment extends each difference value from eight bits (256 tones) to ten bits (1024 tones).

The image processing apparatus according to the present embodiment corrects the color of the left-eye image (an example of the original image which is not the reference image) by using the difference value smoothed in Step S104 to match the color of the left-eye image with the right-eye image (an example of the original image which is the reference image) (S106). Here, examples of the left-eye and right-eye images after the processing in Step S106 include an image in “RGB, 1080p, and 10-bit tones”, like the original image, but the left-eye and right-eye images after the processing in Step S106 are not limited to those described above. For example, the left-eye and right-eye images after the processing in Step S106 may also be images in any format.

The image processing apparatus according to the present embodiment performs, for example, the processing illustrated in FIG. 10 as the processing according to the first example of the image processing method. By performing the processing illustrated in FIG. 10, the processing (difference value calculation processing) described in (1) above and the processing (correction processing) described in (2) above are implemented. Thus, by performing, for example, the processing illustrated in FIG. 10, the image processing apparatus according to the present embodiment can enhance the accuracy of correcting color discrepancy between the left-eye and right-eye images which are components of a stereoscopic image.

### (II) Second Example of Processing According to Image Processing Method According to Present Embodiment

FIG. 11 is a flowchart illustrating a second example of the processing according to the image processing method according to the present embodiment in the image processing apparatus according to the present embodiment. Processing in Steps S200 to S208 in FIG. 11 corresponds to the processing (difference value calculation processing) described in (1) above. Processing in Step S210 in FIG. 11 corresponds to the processing (correction processing) described in (2) above. In FIG. 11, the left-eye and right-eye images are represented by “L” and “R”, respectively.

The image processing apparatus according to the present embodiment divides each of the left-eye and right eye images (original images) (S200). Note that although the image processing apparatus according to the present embodiment, for example, vertically divides each of the left-eye and right eye images (original images) into eight regions, but the number of divided regions of each image in Step S200 is not limited to the number described above. For example, the image processing apparatus according to the present embodiment may divide the left-eye and right eye images (original images) according to the image sizes of the left-eye and right eye images (original images) so that any number of divided regions for reliable histograms can be obtained. More specifically, the image processing apparatus according to the present embodiment specifies the number of divided regions for the left-eye and right eye images (original images) by using, for example, the lookup table in which the image size and the number of divided regions are associated with each other.

The image processing apparatus according to the present embodiment obtains histograms of the left-eye and right-eye images for each of the regions divided in Step S200 (S202). Here, the image processing apparatus according to the present embodiment performs the same processing as in, for example, Step S100 in FIG. 10 in each divided region.

The image processing apparatus according to the present embodiment associates the histograms of the left-eye and right-eye images calculated in Step S202 with each other on the tone basis for each of divided regions corresponding to each other in the left-eye and right-eye images (S204). Here, the image processing apparatus according to the present embodiment performs the same processing as in, for example, Step S102 in FIG. 10 in each corresponding divided region.

After the association in Step S204, the image processing apparatus according to the present embodiment smooths, among the tones, the color difference value between the left-eye and right-eye images which is obtained by the association, in each divided region, in the same manner as in, for example, Step S104 in FIG. 10 (S206).

After smoothing the color difference value between the left-eye and right-eye images in Step S206, the image processing apparatus according to the present embodiment smooths, between adjacent divided regions, the tone-basis difference value smoothed among the tones (S208). By performing the processing in Step S208, it is possible to make less notable a break in an image caused by a slight difference between processing results in the regions.

Here, the image processing apparatus according to the present embodiment smooths, further between adjacent divided regions, the smoothed tone-basis difference value, for example, by calculating an arithmetic average or a weighted average of the adjacent divided regions.

The image processing apparatus according to the present embodiment corrects the color of the left-eye image (an example of the original image which is not the reference image) by using the difference value smoothed in Step S208 in the same manner as in, for example, Step S106 in FIG. 10 to match the color of the left-eye image with the right-eye image (an example of the original image which is the reference image) (S210).

The image processing apparatus according to the present embodiment performs, for example, the processing illustrated in FIG. 11 as the processing according to the second example of the image processing method. By performing the processing illustrated in FIG. 11, the processing (difference value calculation processing) described in (1) above and the processing (correction processing) described in (2) above are implemented. Thus, by performing, for example, the processing illustrated in FIG. 11, the image processing apparatus according to the present embodiment can enhance the accuracy of correcting color discrepancy between the left-eye and right-eye images which are components of a stereoscopic image.

In addition, in the processing, for example, in FIG. 11, the processing (difference value calculation processing) described in (1) above and the processing (correction processing) described in (2) above are performed on the divided region basis. Thus, by performing the processing, for example, in FIG. 11, the image processing apparatus according to the present embodiment can further reduce the possible local color discrepancy between the left-eye and right-eye images.

Note that the processing according to the image processing method according to the present embodiment is not limited to the processing according to the first example illustrated in FIG. 10 and the processing according to the second example illustrated in FIG. 11.

For example, it is possible for the image processing apparatus according to the present embodiment not to perform the processing in Step S208 in FIG. 11. If the processing in Step S208 is not performed, the image processing apparatus according to the present embodiment performs the processing in Step S210 in FIG. 11 by using the tone-basis difference value smoothed among the tones.

Also when the processing in Step S208 is not performed as described above, the processing (difference value calculation processing) described in (1) above and the processing (correction processing) described in (2) above are implemented. Thus, for example, also when the processing in Step S208 is not performed as described above, the image processing apparatus according to the present embodiment can enhance the accuracy of correcting color discrepancy between the left-eye and right-eye images which are components of a stereoscopic image.

### [2-3] Specific Examples of Images Corrected by Using Image Processing Method According to Present Embodiment

Next, there are shown specific examples of images corrected by using the image processing method according to the present embodiment. Note that the examples of images corrected by using the image processing method according to the present embodiment are not limited to the examples to be shown below, as a matter of course.

### (i) First Example of Image Corrected by Using Image Processing Method According to Present Embodiment

FIG. 12 is an explanatory view illustrating a first example of an image corrected by using the image processing method according to the present embodiment. FIG. 12 illustrates an example of an image corrected when the processing according to the image processing method according to the present embodiment is performed on the left-eye and right eye images (original images) in FIG. 1. FIG. 12A illustrates an example of a corrected left-eye image, while FIG. 12B illustrates the original right-eye image.

More specifically, FIG. 12 illustrates an example of a case where the left-eye and right eye images (original images) in FIG. 1 are each vertically divided into eight regions and then the processing (difference value calculation processing) described in (1) above and the processing (correction processing) described in (2) above are performed on the divided region basis.

In comparison between a portion in a square in FIG. 12A and a portion in a square in FIG. 12B, the color discrepancy as in the portions in the squares in FIGS. 2A and 2B does not occur between the left-eye and right-eye images. Thus, the accuracy of correcting color discrepancy between the left-eye and right-eye images which are components of a stereoscopic image is enhanced by performing the processing according to the image processing method according to the present embodiment.

### (ii) Second Example of Image Corrected by Using Image Processing Method According to Present Embodiment

FIG. 13 is an explanatory view illustrating a second example of an image corrected by using the image processing method according to the present embodiment. FIG. 13 illustrates an example of an image corrected when the processing according to the image processing method according to the present embodiment is performed on the left-eye and right eye images (original images) in FIG. 4. FIG. 13A illustrates an example of a corrected left-eye image, while FIG. 13B illustrates the original right-eye image. Moreover, FIG. 13C illustrates a portion in a square in FIG. 13A.

More specifically, FIG. 13 illustrates an example of a case where the left-eye and right eye images (original images) in FIG. 4 are each vertically divided into eight regions and then the processing (difference value calculation processing) described in (1) above and the processing (correction processing) described in (2) above are performed on the divided region basis.

In comparison between FIG. 13A and FIG. 13B, the color discrepancy as illustrated in FIGS. 5A and 5B does not occur between the left-eye and right-eye images. Also in comparison between FIG. 13C and FIG. 6C, the rough gradation as in FIG. 6C is prevented when the image processing method according to the present embodiment is used. Thus, the accuracy of correcting color discrepancy between the left-eye and right-eye images which are components of a stereoscopic image is enhanced by performing the processing according to the image processing method according to the present embodiment.

(iii) Third Example of Image Corrected by Using Image Processing Method According to Present Embodiment

FIG. 14 is an explanatory view illustrating a third example of an image corrected by using the image processing method according to the present embodiment. FIG. 14 illustrates an example of an image corrected when the processing according to the image processing method according to the present embodiment is performed on the left-eye and right eye images (original images) in FIG. 7. FIG. 14A illustrates an example of a corrected left-eye image, while FIG. 14B illustrates the original right-eye image.

More specifically, FIG. 14 illustrates an example of a case where the left-eye and right eye images (original images) in FIG. 7 are each vertically divided into eight regions and then the processing (difference value calculation processing) described in (1) above and the processing (correction processing) described in (2) above are performed on the divided region basis.

In comparison between FIG. 14A and FIG. 14B, the corrected left-eye image in FIG. 14A is corrected so that an upper portion and a lower portion of the image are reddish and greenish, respectively. That is, unlike the left-eye image in FIG. 8A corrected by using the existing image processing method, the corrected left-eye image in FIG. 14A neither has the too reddish lower portion thereof nor the greenish upper portion, and thus the color discrepancy as in FIGS. 8A and 8B does not occur between the left-eye and right-eye images. Thus, the accuracy of correcting color discrepancy between the left-eye and right-eye images which are components of a stereoscopic image is enhanced by performing the processing according to the image processing method according to the present embodiment.

### (iv) Fourth Example of Image Corrected by Using Image Processing Method According to Present Embodiment

FIG. 15 is an explanatory view illustrating a fourth example of an image corrected by using the image processing method according to the present embodiment. FIG. 15 illustrates original images to which the image processing method according to the present embodiment has not been applied yet. FIG. 15A illustrates a left-eye image (original image), while FIG. 15B illustrates a right-eye image (original image).

FIG. 16 is an explanatory view illustrating a fourth example of an image corrected by using the image processing method according to the present embodiment. FIG. 16 illustrates an example of an image corrected when the processing according to the image processing method according to the present embodiment is performed on the left-eye and right eye images (original images) in FIG. 15. FIG. 16A illustrates an example of a corrected left-eye image, while FIG. 16B illustrates the original right-eye image.

More specifically, FIG. 16 illustrates an example of a case where the left-eye and right eye images (original images) in FIG. 15 are each vertically divided into eight regions and then the processing (difference value calculation processing) described in (1) above and the processing (correction processing) described in (2) above are performed on the divided region basis.

In comparison between FIG. 16A and FIG. 16B, the color discrepancy as in FIGS. 15A and 15B does not occur between the left-eye and right-eye images. Thus, the accuracy of correcting color discrepancy between the left-eye and right-eye images which are components of a stereoscopic image is enhanced by performing the processing according to the image processing method according to the present embodiment.

### (Image Processing Apparatus According to Present Embodiment)

Next, a description is given of a configuration example of the image processing apparatus according to the present embodiment capable of performing the aforementioned processing according to the image processing method according to the present embodiment.

FIG. 17 is a block diagram illustrating a configuration example of an image processing apparatus 100 according to the present embodiment. The image processing apparatus 100 includes a control section 102, for example.

The image processing apparatus 100 may also include, for example, a ROM (Read Only Memory not shown), a RAM (Random Access Memory not shown), the storage section (not shown), a communication section (not shown), a manipulation section manipulatable by the user (not shown), and a display section which displays various screens on a display screen (not shown). The image processing apparatus 100 connects the components with each other, for example, via a bus which is a data transmission channel.

Here, the ROM (not shown) stores programs and control data such as operation parameters all of which are used by the control section 102. The RAM (not shown) temporarily stores the programs executed by the control section 102, and the like.

The storage section (not shown) is storage means included in the image processing apparatus 100 and stores various data such as image data and applications. Here, examples of the storage section (not shown) include a magnetic recording medium such as a hard disk (Hard Disk), and a nonvolatile memory such as a flash memory. The storage section (not shown) may also be attachable to and detachable from the image processing apparatus 100.

As the communication section (not shown), a communication interface to be described later is cited. In addition, a manipulation input device and a display device which are to be described later are cited as the manipulation section (not shown) and the display section (not shown), respectively.

### [Hardware Configuration Example of Image Processing Apparatus 100]

FIG. 18 is an explanatory view illustrating an example of a hardware configuration of the image processing apparatus according to the present embodiment 100. The image processing apparatus 100 includes, for example, an MPU 150, a ROM 152, a RAM 154, a recording medium 156, an input/output interface 158, a manipulation input device 160, a display device 162, and a communication interface 164. In addition, the image processing apparatus 100 connects the components with each other by using, for example, a bus 166 serving as a data transmission channel.

The MPU 150 is configured of, for example, an MPU (Micro Processing Unit), various processing circuits, and serves as the control section 102 which controls the entire image processing apparatus 100. In the image processing apparatus 100, the MPU 150 also serves as, for example, a difference value calculation section 110, a correction section 112, and an image processing section 114 which are to be described later.

The ROM 152 stores programs, control data such as operation parameters, and the like which are used by the MPU 150. The RAM 154 temporarily stores the programs executed by the MPU 150 and the like, for example.

The recording medium 156 serves as the storage section (not shown) and stores various data such as image data and applications. Here, examples of the recording medium 156 include a magnetic recording medium such as a hard disk, and a nonvolatile memory such as a flash memory. The recording medium 156 may also be attachable to and detachable from the image processing apparatus 100.

The input/output interface 158 performs connection with, for example, the manipulation input device 160 and the display device 162. The manipulation input device 160 and the display device 162 serve as the manipulation section (not shown) and the display section (not shown), respectively. Here, examples of the input/output interface 158 include a USB (Universal Serial Bus) terminal, a DVI (Digital Visual Interface) terminal, an HDMI (High-Definition Multimedia Interface) terminal, and various processing circuits. In addition, the manipulation input device 160 is provided, for example, on the image processing apparatus 100, and is connected to the input/output interface 158 inside the image processing apparatus 100. Examples of the manipulation input device 160 include buttons, direction keys, a rotary selector such as a jog dial, and combinations thereof. The display device 162 is provided, for example, on the image processing apparatus 100, and is connected to the input/output interface 158 inside the image processing apparatus 100. Examples of the display device 162 include a Liquid Crystal Display (LCD), an organic ElectroLuminescence display, an Organic Light Emitting Diode display (OLED).

It goes without saying that the input/output interface 158 may be connected to external devices such as a manipulation input device (such as a keyboard or a mouse) and a display device which serve as external devices of the image processing apparatus 100. The display device 162 may be a device, such as a touch screen, enabling display and user manipulation.

The communication interface 164 is communication means included in the image processing apparatus 100, and serves as the communication section (not shown) for wireless/wired communications with external devices such as a display device, a server, an imaging apparatus, through a network (or directly). Here, examples of the communication interface 164 include: a communication antenna and an RF (Radio Frequency) circuit (wireless communication); an IEEE802.15.1 port and transmission and reception circuits (wireless communication); an IEEE802. 11b port and transmission and reception circuits (wireless communication); and a LAN (Local Area Network) terminal and transmission and reception circuits (wired communication). Examples of a network according to the present embodiment include: a wired network such as a LAN or a WAN (Wide Area Network); a wireless network such as a wireless LAN (WLAN; Wireless Local Area Network) or a wireless WAN (WWAN; Wireless Wide Area Network) having base stations; and the Internet using such a communication protocol as TCP/IP (Transmission Control Protocol/Internet Protocol).

The image processing apparatus 100 performs the processing according to the image processing method according to the present embodiment, for example, in the configuration in FIG. 18. Note that the hardware configuration of the image processing apparatus 100 according to the present embodiment is not limited to the configuration in FIG. 18.

For example, the image processing apparatus 100 may include an imaging device serving as the imaging section (not shown) which captures still images or moving images. When including the imaging device, the image processing apparatus 100 can, for example, process captured images generated by image capturing by the imaging device.

Here, examples of the imaging device according to the present embodiment include lenses/imaging elements and signal processing circuits. The lenses/imaging elements include, for example, an image sensor using a plurality of optical system lenses and imaging elements such as CMOSs (Complementary Metal Oxide Semiconductors). The signal processing circuits include, for example, an AGC (Automatic Gain Control) circuit and an ADC (Analog to Digital Converter), and convert analog signals generated by the imaging elements into digital signals (image data) to perform a wide variety of signal processing. Examples of the signal processing by the signal processing circuits include White Balance correction processing, hue correction processing, gamma correction processing, YCbCr conversion processing, and edge enhancing processing.

When having, for example, a configuration for standalone processing, the image processing apparatus 100 does not have to include the communication interface 164. The image processing apparatus 100 may also have a configuration without the manipulation input device 160 and the display device 162.

With reference to FIG. 17 again, the configuration example of the image processing apparatus 100 is described. The control section 102 is configured of, for example, an MPU and plays a role of controlling the entire image processing apparatus 100. The control section 102 includes, for example, the difference value calculation section 110, the correction section 112, and the image processing section 114, and plays a leading role of performing the processing according to the image processing method according to the present embodiment.

The difference value calculation section 110 plays a leading role of performing the processing (difference value calculation processing) described in (1) above. More specifically, for example, the difference value calculation section 110 associates the histograms indicating the number of pixels per tone of respective left-eye and right-eye images with each other on the tone basis, calculates the difference value between the left-eye and right-eye images on the associated tone basis, and then smooths the calculated difference value among the tones.

The difference value calculation section 110 may also divide and process, for example, each of the left-eye and right-eye images. More specifically, the difference value calculation section 110 may calculate the difference value, for example, on the basis of divided regions corresponding to each other in the left-eye and right-eye images, and may smooth, among the tones on the divided region basis, the difference value calculated on the divided region basis. Further, when smoothing the difference value, among the tones on the divided region basis, the difference value calculation section 110 may smooth the smoothed tone-basis difference value between adjacent divided regions.

The correction section 112 plays a leading role of performing the processing (correction processing) described in (2) above, and corrects the left-eye or right-eye image based on the tone-basis difference value smoothed by the difference value calculation section 110.

In addition, when the difference value calculation section 110 calculates the difference value on the divided region basis, the correction section 112 corrects the left-eye or right-eye image on the divided region basis, for example, based on the difference value smoothed among the tones on the divided region basis or based on the difference value further smoothed between the adjacent divided regions, the difference values being smoothed by the difference value calculation section 110.

The image processing section 114 plays a leading role of performing the viewpoint-image generation processing described above, and generates one or more images each in a viewpoint different from the viewpoints of the left-eye and right-eye images. The image processing section 114 sets, for example, the left-eye or right-eye image as a reference image, and generates an image in which the reference image is shifted by a set phase difference. Note that as described above, the image processing section 114 may generate an image in another viewpoint, for example, by performing processing according to any viewpoint-image-generation technique enabling generation of an image in another viewpoint (multi-view image generation processing, for example).

The control section 102 includes, for example, the difference value calculation section 110, the correction section 112, and the image processing section 114, and thereby takes the lead in performing the processing according to the image processing method according to the present embodiment (for example, the processing (difference value calculation processing) described in (1) above, the processing (correction processing) described in (2) above, and the viewpoint-image generation processing described above).

Note that the configuration of the control section according to the present embodiment is not limited to the configuration in FIG. 17. For example, the control section according to the present embodiment does not have to include the image processing section 114. Even when not including the image processing section 114, the control section according to the present embodiment can perform the processing (difference value calculation processing) described in (1) above and the processing (correction processing) described in (2) above according to the image processing method according to the present embodiment. Thus, even when not including the image processing section 114, the control section according to the present embodiment can enhance the accuracy of correcting color discrepancy between the left-eye and right-eye images which are components of a stereoscopic image.

With the configuration, for example, in FIG. 17, the image processing apparatus 100 performs the processing according to the image processing method according to the present embodiment (for example, the processing (difference value calculation processing) described in (1) above, the processing (correction processing) described in (2) above, and the viewpoint-image generation processing) described above. Thus, with the configuration, for example, in FIG. 17, the image processing apparatus 100 can enhance the accuracy of correcting color discrepancy between the left-eye and right-eye images which are components of a stereoscopic image.

Note that the configuration of the image processing apparatus according to the present embodiment is not limited to the configuration in FIG. 17.

For example, the image processing apparatus according to the present embodiment may individually include the difference value calculation section 110, the correction section 112, and the image processing section 114 which are illustrated in FIG. 17 (for example, may be implemented using respective processing circuits).

The image processing apparatus according to the present embodiment may also have a configuration, for example, without the image processing section 114 taking the lead in performing the viewpoint-image generation processing described above. even when having the configuration without the image processing section 114, the image processing apparatus according to the present embodiment can perform the processing (difference value calculation processing) described in (1) above and the processing (correction processing) described in (2) above according to the image processing method according to the present embodiment. Thus, even when not including the image processing section 114 the image processing apparatus according to the present embodiment can enhance the accuracy of correcting color discrepancy between the left-eye and right-eye images which are components of a stereoscopic image.

In addition, the image processing apparatus according to the present embodiment may include, for example, the imaging section (not shown). When including the imaging section (not shown), the image processing apparatus according to the present embodiment can process a captured image generated by image capturing by the imaging section (not shown). Examples of the imaging section (not shown) include the aforementioned imaging device according to the present embodiment.

As described above, the image processing apparatus according to the present embodiment performs, for example, the processing (difference value calculation processing) described in (1) above and the processing (correction processing) described in (2) above, as the processing according to the image processing method according to the present embodiment. Note that in the processing (difference value calculation processing) described in (1) above, the image processing apparatus according to the present embodiment calculates the difference value between the left-eye and right-eye images on the associated tone basis, and smooths the calculated difference value among the tones. Then, in the processing (correction processing) described in (2) above, the image processing apparatus according to the present embodiment corrects the left-eye or right-eye image based on the smoothed tone-basis difference value. Thus, the image processing apparatus according to the present embodiment can further reduce the local color discrepancy possibly occurring in using the existing image processing method described above.

Thus, the image processing apparatus according to the present embodiment can enhance the accuracy of correcting color discrepancy between the left-eye and right-eye images which are components of a stereoscopic image.

In addition, the processing according to the image processing method according to the present embodiment is simple, and thus can be achieved without a high cost even in the case of implementation as a signal processing circuit (hardware).

The description has heretofore been given by taking the image processing apparatus as the present embodiment, but the present embodiment is not limited to the mode. The present embodiment is applicable to various devices capable of image processing, such as: a tablet device; a communication device which is a mobile phone, smartphone, or the like; a video/music reproducing device (or a video/music recording and reproducing device); a game machine; a computer such as a PC (Personal Computer), and an imaging apparatus such as a digital camera or a digital video camera. The present embodiment is also applicable to, for example, a processing IC (Integrated Circuit) which can be incorporated into the device as described above.

### (Program According to Present Embodiment)

It is possible to enhance the accuracy of correcting color discrepancy between the left-eye and right-eye images which are components of a stereoscopic image by executing, by a computer, a program causing the computer to function as the image processing apparatus according to the present embodiment (a program enabling execution of the processing according to the image processing method according to the present embodiment such as “the processing (difference value calculation processing) described in (1) above and the processing (correction processing) described in (2) above” or “the processing (difference value calculation processing) described in (1) above, the processing (correction processing) described in (2) above, and the viewpoint-image generation processing described above”).

The preferred embodiment of the present disclosure has heretofore been described in detail with reference to the appended drawings, but the technical scope of the present disclosure is not limited to the example. It should be understood by those skilled in the art that various modifications, combinations, sub-combinations and alterations may occur depending on design requirements and other factors insofar as they are within the scope of the appended claims or the equivalents thereof.

For example, the description above shows that the program (computer program) causing the computer to function as the image processing apparatus according to the present embodiment is provided. However, in the present embodiment, a recording medium in which the program is stored can be provided together.

The aforementioned configuration is merely an example of the present embodiment and naturally within the technical scope of the present disclosure.

Additionally, the present disclosure may also be configured as below.

(1) An image processing apparatus including:

a difference value calculation section which associates, with each other on a tone basis, histograms indicating a number of pixels per tone in a left-eye image and a right-eye image, respectively, the left-eye image and the right-eye image being components of a stereoscopic image, which calculates a difference value between the left-eye image and the right-eye image on the associated tone basis, and which smooths the calculated difference value among tones; and

a correction section which corrects the left-eye image or the right-eye image based on the smoothed tone-basis difference value.

(2)
The image processing apparatus according to (1),

wherein the difference value calculation section performs regional division on each of the left-eye image and the right-eye image, calculates the difference value on a basis of divided regions corresponding to each other in the left-eye image and the right-eye image, and smooths, among the tones and on the divided region basis, the difference value calculated on the divided region basis, and

wherein the correction section corrects the left-eye image or the right-eye image on the divided region basis.

(3)
The image processing apparatus according to (2),

wherein the difference value calculation section further smooths the smoothed tone-basis difference value, between adjacent divided regions.

(4)
The image processing apparatus according to any one of (1) to (3),

wherein the difference value calculation section calculates the histograms in such a manner as to decrease a number of tone bits of the left-eye image and the right-eye image.

(5)
The image processing apparatus according to any one of (1) to (4), further including:

an image processing section which generates one or more images in another viewpoint different from viewpoints of the left-eye image and the right-eye image.

(6)
An image processing method including:

associating, with each other on a tone basis, histograms indicating the number of pixels per tone in a left-eye image and a right-eye image, respectively, the left-eye image and the right-eye image being components of a stereoscopic image, calculating a difference value between the left-eye image and the right-eye image on the associated tone basis, and smoothing the calculated difference value among tones; and

correcting the left-eye image or the right-eye image based on the smoothed tone-basis difference value.

The present disclosure contains subject matter related to that disclosed in Japanese Priority Patent Application JP 2012-194539 filed in the Japan Patent Office on Sep. 4, 2012, the entire content of which is hereby incorporated by reference.

What is claimed is:

1. An image processing apparatus comprising:
a difference value calculation section which associates, with each other on a tone basis, histograms indicating a number of pixels per tone in a left-eye image and a right-eye image, respectively, the left-eye image and the right-eye image being components of a stereoscopic image, which calculates a difference value between the left-eye image and the right-eye image on the associated tone basis, and which smooths the calculated difference value among tones; and
a correction section which corrects the left-eye image or the right-eye image based on the smoothed tone-basis difference value.

2. The image processing apparatus according to claim 1,
wherein the difference value calculation section performs regional division on each of the left-eye image and the right-eye image, calculates the difference value on a basis of divided regions corresponding to each other in the left-eye image and the right-eye image, and smooths, among the tones and on the divided region basis, the difference value calculated on the divided region basis, and
wherein the correction section corrects the left-eye image or the right-eye image on the divided region basis.

3. The image processing apparatus according to claim 2,
wherein the difference value calculation section further smooths the smoothed tone-basis difference value, between adjacent divided regions.

4. The image processing apparatus according to claim 1,
wherein the difference value calculation section calculates the histograms in such a manner as to decrease a number of tone bits of the left-eye image and the right-eye image.

5. The image processing apparatus according to claim 1, further comprising:
an image processing section which generates one or more images in another viewpoint different from viewpoints of the left-eye image and the right-eye image.

6. An image processing method comprising:
associating, with each other on a tone basis, histograms indicating the number of pixels per tone in a left-eye image and a right-eye image, respectively, the left-eye image and the right-eye image being components of a stereoscopic image, calculating a difference value between the left-eye image and the right-eye image on the associated tone basis, and smoothing the calculated difference value among tones; and
correcting the left-eye image or the right-eye image based on the smoothed tone-basis difference value.
